(19) United States
(12) Patent Application Publication
(10) Pub. No.: US 2011/0048853 A1
(43) Pub. Date: Mar. 3, 2011

(54) CLIMBING DEVICE

(76) Inventor: Christopher Gavin Brickell, Docklands (AU)

(21) Appl. No.: 12/870,710

(22) Filed: Aug. 27, 2010

Related U.S. Application Data
(63) Continuation of application No. PCT/US10/46687, filed on Aug. 25, 2010.
(60) Provisional application No. 61/237,432, filed on Aug. 27, 2009.

(30) Foreign Application Priority Data
Aug. 25, 2010 (US) PCT/US10/46687

(51) Int. Cl. E06C 7/18; A62B 1/16

(52) U.S. Cl. 182/5

(57) ABSTRACT

A climb assist system is disclosed that adjusts the rate and level of assist of a climber and starts/stops the level of assist as the climber needs may change over the period of traverse of the ladder. A sensor may detect a change in the operating state of a motor in the climb assist system. For example, the change in state may indicate a change in the load exerted by the climber indicating that the climber intends to start or stop an active climb. The climb assist system may then adjust the inputs to the motor to initiate a climb or terminate a climb.

### CROSS-REFERENCE TO RELATED APPLICATION

This application claims the benefit of PCT Application No. PCT/US10/46687 filed Aug. 25, 2010, which claims the benefits of U.S. Provisional Application No. 61/237,432 filed Aug. 27, 2009, of which is herein incorporated by reference in its entirety.

### BACKGROUND

Systems that assist a climber in ascent and descent climbing are known. Some systems, for example, use a counterweight to counter balance the weight of the climber other use a power assist mechanism. The prior systems assist with tasks such as ladder climbing such as may be found in towers, cranes, oil derricks, buildings, etc.

In order to initiate the climb assistance, systems employ a variety of techniques. For example, systems use pulling on a separate line from that used to support the climber; pulling on the support line to disengage a switch mechanism; and pulling on the support line to displace a sensor for a time duration.

A significant requirement for a person climbing a ladder using such a motorized system and being remote from the motor and power source is to be able to conveniently start and stop the system at will. A climber, for example in a wind tower, may need to stop at several points in the tower. For example, a climber may stop at a landing hatch that must be opened and closed during passage throughout the landing, and also at the climb terminal points. To be able to restart the climb in either the up or down direction, the motor controller must also be signaled of the climber's intent and to react accordingly.

### SUMMARY

Various embodiments, systems, methods, and computer-readable media are disclosed for managing the start and stop process of an assisted climb in a simple and low cost manner and provide a smooth and jerk-free operation for the climber. Various embodiments provide for the start and stop of the active assist of a climber and provide a selected level of support for the climber at any point on the associated ladder, including the termination of support. The present disclosure may be applied to both endless belt systems, defined as one where the belt may rotate more than one half revolution through the sheaves, and to a half-cycling system defined as one where the belt joint point or the attachment point may not rotate through sheaves, thereby limiting rotation to nominally one half revolution.

In addition to the foregoing, other aspects are described in the claims, drawings, and text forming a part of the present disclosure. The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The foregoing summary, as well as the following detailed description of preferred embodiments, is better understood when read in conjunction with the appended drawings. For the purposes of illustration, there are shown in the drawings exemplary embodiments; however, the present disclosure is not limited to the specific methods and instrumentalities disclosed. In the drawings:

FIG. 1 illustrates an example embodiment of a climb assist system disclosed herein.

FIG. 1A illustrates a front view of portion of a ladder with the claim assist.

FIG. 2 illustrates an example embodiment of a motor and drive disclosed herein.

FIG. 2A illustrates one implementation of a control system disclosed herein.

FIG. 3 illustrates an example embodiment of a control system disclosed herein.

FIG. 4 depicts equations related to an example embodiment of motor control disclosed herein.

FIG. 5 illustrates an example embodiment of sensor signals disclosed herein.

FIG. 5B illustrates an example of an alternative embodiment of sensor signals disclosed herein.

FIG. 6 illustrates an example embodiment of an initiation algorithm.

FIG. 7 illustrates an example embodiment of a control algorithm.

FIG. 8 depicts an exemplary process incorporating some of the embodiments disclosed herein.

FIG. 9 depicts an example system for providing climbing assistance.

### DETAILED DESCRIPTION OF ILLUSTRATIVE EMBODIMENTS

Certain specific details are set forth in the following description and figures to provide a thorough understanding of various embodiments of the disclosure. Certain well-known details often associated with climbing devices are not set forth in the following disclosure to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure.

Many structures such as a wind tower platform require access to the upper areas of the structure for maintenance, inspection, and repairs. However, climbing a ladder requires significant physical exertion, especially when dealing with higher altitudes and extreme temperatures. A climbing assist device may enable workers to more easily climb ladders and conduct periodic maintenance at various levels of the tower. If the climb assist device can maintain a person's position, then the need for working platforms at landings or intermediate tower levels may be alleviated.

A climbing assist device may be used to aid a climber to ascend or descend a ladder or a similar climbing apparatus. Such an apparatus may be used to climb a wind tower, radio tower, or other such structures.

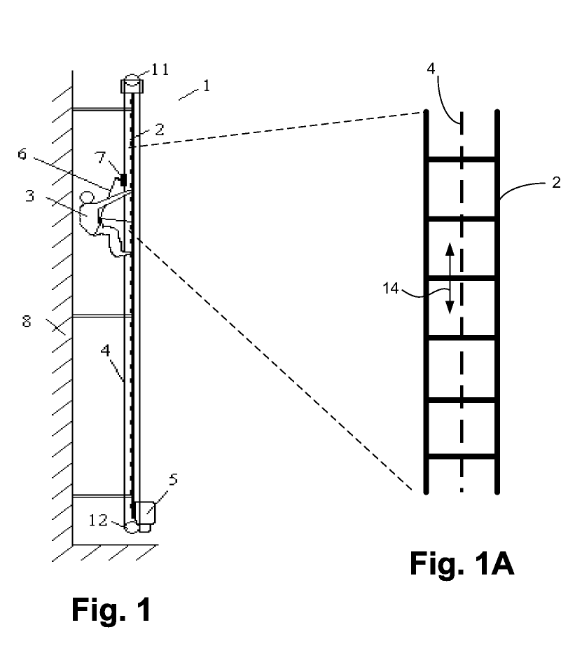

FIG. 1 shows a schematic climb assist system 1 and a side view of a climber 3 on a ladder 2 during ascent or descent on a structure 8. In an exemplary embodiment, climber 3 may be a service person climbing a ladder 2 during routine maintenance of a wind generating tower that may include climb assist system 1. Climber 3 may be attached by a rope grab 7 to an assist rope 4. The assist rope 4 may provide support to the climber 3 by exerting an upward support force on the climber 3 to compensate for a portion of the climber 3's weight. In some embodiments, the amount of support may be a selectable portion of the climber 3's weight.

The assist rope 4 may be a unidirectional loop or an continuous/endless loop, and is preferably configured as a continuous/endless loop. The assist rope 4 may consist of material such as flexible wire or natural or synthetic rope with appropriate modifications or coatings to ensure efficacy in the application. Generally an endless belt may be made from a length of material and spliced or welded in place to form the endless loop. In some cases the endless belt may be referred to as a climb assist loop.

The assist rope 4 may extend between sheave 11 at a selected upper level of assist and sheave 12 at the selected lower level of assist. The assist rope 4 and associated components may collectively be referred to as a rigging. A rigging generally comprises a network of lines and/or ropes for support and manipulation of a load.

The preferred range of assist to the climber may be in the range of 50 (lbf) and 125 lbf. This range is exemplary and other high or low limits may be selected. Furthermore, it should be readily recognized that such a climb assist system may be used to assist a climber for ascending and descending other structures such as signal towers, bridges, dams, skyscrapers and the like.

In the example embodiment of FIG. 1, the preferred location of the drive system 5 is at the lower level and provides drive to the lower level sheave 12. Of course, alternative locations for the drive system may also be used, for example at the top of the ladder, and in some installations this may be determined by the location of a power outlet. Other layouts are also possible, such as placing the motor section between the top and bottom of the ladder, or at a location separated from the ladder and directing the belt as required with additional sheaves.

Attachment to assist rope 4 may be provided by a lanyard 6 connected between a commercially available body harness (not shown) worn by the climber and rope grab 7. Optionally, lanyard 6 may be replaced by other coupling means between rope grab 7 and the body harness. Additionally and as required by Occupational Safety and Health Administration (OSHA) regulations, climber 3 should be connected to an appropriate fall arrest device which is not further discussed in this disclosure.

FIG. 1A shows a front view of a section of ladder 2 and assist rope 4 positioned proximate a center line of ladder 2. Other configurations of assist rope 4 are possible, such as to the left or right of center.

Aspects of this disclosure may relate to dynamic adjustment of the rate of assist provided to climber 3 as manifested by the ascent/descent speed of assist rope 4 and the level of assist of climber 3 as manifested by the support of the load that the climber exerts on assist rope 4. The needs of climber 3 may change during the period of traverse of the ladder as the climber may climb slower or faster than the speed of assist rope 4 and as the weight of climber 3 varies between individual climbers. Consequently, the disclosed system may take into account factors such as the climber's fitness, weight and desired climb speed.

The climbing assist system 1 may further comprise a controlled drive and motor to provide motive power to the support or assist rope. A sensor may be provided for detecting the load the climber on the ladder exerts on the support belt. A controller may be provided to interpret the sensed data to provide control signals.

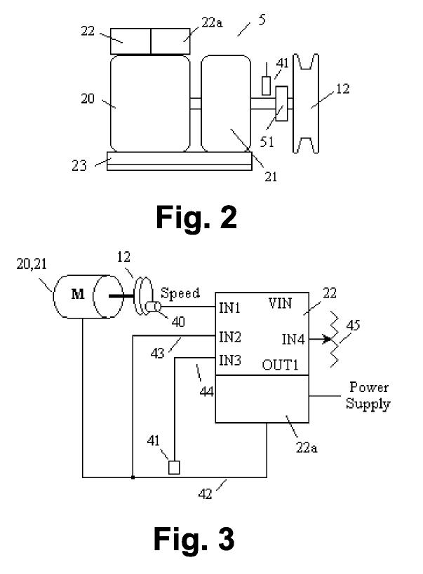

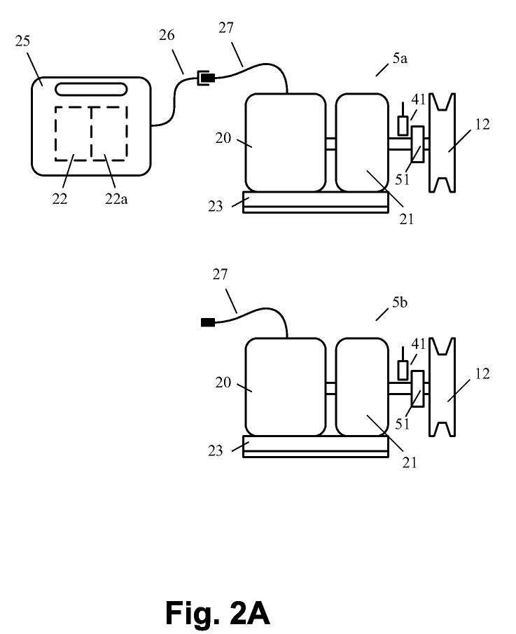

FIG. 2 illustrates an example of an embodiment of the motor and drive. Motor 20 may provide motive power to drive sheave 12 and hence assist rope 4 via an optional reduction gearbox 21. As the sheaves rotate, assist rope 4 may move in the direction of rotation to assist or carry climber 3 up or down according to the motor rotational direction (as illustrated by arrow 14 in FIG. 1A), thereby relieving the attached climber's weight as a function of the tension in the loop and hence the assist rope 4.

Controller 22 may include a mechanism that senses the operating conditions of motor 20 such as current, voltage and motor or sheave rotational speed. Controller 22 may also include a mechanism that provides control actions such as maintaining a specified torque, speed, power or a combination thereof including limit values so as to provide the desired functional conditions. For convenience of explanation, controller 22 is depicted as comprising two functional units, namely a controller 22 to determine a control signal from sensed conditions, and a motor drive 22a to provide a supply voltage to motor 20 as a function of the control signal. In other embodiments, the motor drive may be integrated within controller 22 or provided as a separate connected module as desired for the application.

The motor drive, for example, may be selected as a 2-quadrant drive optionally including dynamic braking As another example, the motor drive may be selected as a 4-quadrant drive optionally including regenerative braking.

Those skilled in the art will recognize that the support provided to climber 3 may be equivalent to the tension in the connection, and may be directly reflected in the torque delivered by motor 20, the torque being the product of the tension and radius of sheave 12.

FIG. 2A illustrates one implementation of the control system 22 and 22a. Instead of being permanently attached to or integral with drive system 5, control system 22 and 22a can be contained in a portable control box 25. Preferably, portable control box 25 is rugged and lightweight, making it durable and easy to carry. Control box 25 includes a connector 26 which can connect with mating connector 27 of drive system 5a or mating connector 27 of drive system 5b. When control box 25 is connected to drive system 5a, control system 22 and 22a receives signals indicative of sensed conditions in drive system 5a and determines a control signal for feedback to drive system 5a. The signals indicative of the sensed conditions and the control signals are communicated via the link established by connector 26 and mating connector 27.

One advantage of the implementation depicted in FIG. 2A is that the control system 22 and 22a can be personalized to a single climber, and that climber can use the control system 22 and 22a with any drive system that is equipped with a mating connector 27. As described below in greater detail, the control system 22 and 22a can be personalized to a specific climber based on a number of factors such as the climber's weight, the climber's typical rate of climb, and other factors. If drive systems 5a and 5b each had their own control system 22 and 22a, the personalization setting would need to be adjusted each time that a different climber used them. Instead, as depicted in FIG. 2A, drive systems 5a and 5b do not have a permanently attached control system 22 and 22a, but they each have a mating connector 27. Control box 25 includes control system 22 and 22a which are personalized to a specific climber. That climber can attach control box 25 to drive system 5a when climbing on a ladder associated with drive system 5a, and then easily disconnect control box 25 from drive system 5a and connect to drive system 5b when climbing on a ladder associated with drive system 5b.

FIG. 3 illustrates an embodiment of the control system 22 and 22a.

It can be seen that climber behavior such as variability of the climber's speed during climbing may cause variations in instantaneous support, and it can be considered a preferred function of the control system to maintain support at a selected level.

In one embodiment, by monitoring the motor current and/or voltage when the motor 20 is loaded by a climber 3 attached to the assist rope 4, the direction in which the climber 3 intends to climb may be determined. The motor 20 may thus be powered in accordance with the sensed direction, and also to maintain a selected level of support. Those skilled in the art will readily recognize the use of current measurement to manage motor torque and that such use may be a feature of various commercially available motor drives, such as the Siemens brand Simoreg variable speed drives, or as detailed in the book “Sensorless Vector and Direct Torque Control” by Peter Vas.

A sensor for detecting a load that a climber exerts on an assist rope may be incorporated into the climbing assist system 1 in order to allow for control of the amount of power needed to assist the climber. Additionally, the climbing assist system 1 may also include a sender to transmit the load data to a receiver, a transmission path, a receiver to receive the data from the sender, a supervisory controller to interpret the received data, and a controlled motor and drive to provide energy to the assist rope 4. It should be noted that sensors for detecting a change in a load exerted by a person is only one example of determining a state of the climber. Additionally and optionally, sensors for detecting other changes in the state of a climber may be employed. For example, changes in eye movement, body temperature, heart rate, or other physical data may also provide indications of a climber's state and physical attributes.

In an embodiment, as the motor current and/or voltage is monitored, the intention of the climber to stop climbing may also be determined, whereupon power to motor 20 may be terminated, thereby terminating the motive support provided to the climber.

Moreover, the system also contemplates that the climber may manually signal intent by manually tugging on the assist rope. For example, the climber may tug the rope in the up direction which would be sensed by the controller 22a as a corresponding change in motor voltage and/or current. In response, the system could take an appropriate action based on that such as providing power to assist rope 4 in the up direction. Similarly, the climber could manually tug on assist rope 4 in the down direction, which could in turn be sensed as a corresponding change in motor voltage and/or current. Such a mechanism could be used to create a set of signals which could in turn be used to control the system. For example, two up tugs on assist rope 4 could be used to sense a change in voltage and/or current to provide more assist power than, say, a single up tug. Similarly, two down tugs on assist rope 4 could be used to apply more or less assist power in the down direction and so on.

In the embodiments disclosed herein, a permanent magnet DC motor is used to provide the motive power for illustrative purposes. However, those skilled in the art will recognize that a permanent magnet DC motor is only one example and that other types of DC motors and AC motors may be used. Those skilled in the art will also recognize that motor speed may be measured using a sensor such as an inductive type sensor and sensing shaft or sheave rotation. In other examples, sensing motor counter EMF may be used. All such embodiments are contemplated by the present disclosure.

In an embodiment, closed loop adjustment of the power to motor 20 and hence the amount of support provided to the climber 3 may be maintained in order to maintain the level of support at a nominally constant value, independently of the climb speed determined from the climber's behavior. A climber's needs may change over the period of traverse of the ladder as the climber may desire to change the rate of the climb. Furthermore, the level of climber support may change as different climbers with different preferences may use the system. Thus in some embodiments, the support level may be selectable and thus take into account additional factors such as climber fitness, weight and climb speed.

A climb assist system that incorporates aspects of the systems described herein may allow for a reduction in the number of specialized components in the system. Reliability and maintainability may also be improved, thus allowing for greater utilization and lower cost.

By incorporating an endless support belt, multiple climbers may sequentially climb or descend a ladder without the need to rewind the belt between climbs, hence eliminating delay for climbers waiting for the rewind to complete. Belt rewind may be required by climb assist systems such as those typified by counterweight systems where the point of attachment to the climber needs to be returned to the climb initiation point before a second climber may climb in the same direction as the first. That said, aspect of the systems described herein could also be applied to a belt rewind system.

The equations below depict approximation equations for operation with reference to a preferred motor type such as a Permanent Magnet Direct Current (PMDC) type. A characteristic of such a motor is that the field flux is essentially constant, which may provide for simplification in control preferentially by applying voltage to the motor. Because the torque delivered or absorbed by the motor is a function of motor current, the level of climber support can be estimated by a measure of motor current.

$$\begin{matrix}{V}_{m} = {K}_{m} {N}_{m} φ + {I}_{m} {R}_{m} & ( 1 \\ {T}_{m} = {I}_{m} φ & ( 2 \\ {P}_{s} = {K}_{c} {T}_{s} {N}_{s} & ( 3 \\ {S}_{b} = {T}_{s} / r & ( 4 \\ {S}_{b} = {I}_{m} φ / r \\ Also \text{:} & ( 4 a \\ {V}_{c} = {N}_{m} φ \\ From ( 1 \text{:} & ( 5 \\ {V}_{c} = ( {V}_{m} - {I}_{m} {R}_{m} ) / {K}_{m} & ( 6 \\ {P}_{i} = {I}_{m} \cdot {V}_{m} ∝ {N}_{s} * {T}_{s} & ( 7 \\ {T}_{s} = L * r & ( 8 \\ ∴ {I}_{m} \cdot {V}_{i} ∝ * {N}_{s} * {T}_{s} & ( 9 \\ {N}_{s} ∝ {I}_{m} \cdot {V}_{m} / L & ( 10\end{matrix}$$

where:
Vₘ=motor terminal voltage
Iₘ=motor current
Kₘ=motor constant
Nₘ=motor rotational speed
Nₛ=output shaft rotational speed
φ=field flux density (˜constant)
Rₘ=motor armature resistance
Tₛ=shaft torque
VK_{c}=conversion constant
S_{b}=support load at belt
r=sheave radius (eg 12 FIG. 1)
V_{c}=counter-emf
P₁=motor input power
L=climber support load
c=constant

Motor current Iₘ may be sensed using a commercially available method such as a current transformer or HED magnetic field sensor 41 adjacent to a conductor carrying current to the motor. In the present example, a HED is used and placed in proximity to a conductor carrying current to the motor. Current sensing is well known to those skilled in the art and is not further discussed herein.

The voltage 42, which is the counter emf at the motor supply terminals Vₘ, may be measured at 43. Voltage 42 may be used to sense motor operating speed during periods when the supply voltage is removed from the motor and when the motor is acting as a generator according to equation (6).

Alternatively, motor or sheave speed Sₘ may be sensed using any number of commercially available methods such as inductive or optical sensors adjacent to a rotating member. In the present example, a Hall Effect Device (HED) is assumed in which splines may be evenly distributed around a motor or gearbox shaft or holes are evenly distributed and are sensed around, for example, the sheave. In other embodiments, holes in a rotating ferromagnetic disk may also be sensed.

The measurements may then be made available to the controller. The controller may comprise a microprocessor and incorporate associated conversion devices configured to provide desired control actions that operate in accordance with selected algorithms responsive to the measurements.

In an exemplary algorithm incorporating a PMDC motor, the power transferred from the motor via the gearbox to the belt to provide the required level of support to the climber may be set by changing Vₘ and hence changing the torque at the gearbox, in accordance with the described equations.

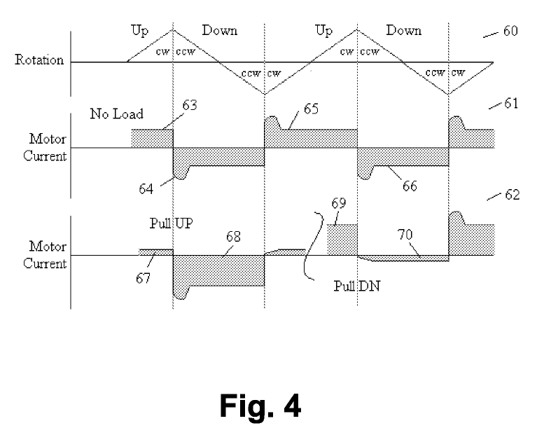

Losses between the electrical power input to the motor and mechanical power output of the reduction gearbox output shaft may result from dissipation in the motor winding and inefficiencies in the gearbox. In embodiments in which the gearbox is included to allow a motor of lower torque rating to be selected instead of a motor directly coupled to the drive sheave with the gearbox, the reduction ratio may be represented by Nₘ/Nₛ as shown in FIG. 4.

It can be seen from equation (4a) that by measuring motor current, the support may be sensed and that an increase in motor current corresponds to an increase in support provided by the belt. Similarly, the current may decrease as the support decreases.

It can also be seen from equation (1) that by measuring and controlling motor current Iₘ, the amount of support at the assist rope may be controlled. In a preferred embodiment, the method of control is by controlling the motor voltage supply.

To control the support provided to the climber, the current may be controlled using, for example, a PID control algorithm as is known to those skilled in the art. Other methods may be used to provide torque control, such as control of the magnetic field as can be seen from equation (1).

The load control method may depend on the motor type. While the above discussion relates to control of a PMDC motor, other types of motors, for example an AC induction motor, may be selected to provide a specified torque by controlling the voltage and frequency of the supply and hence the slip relative to synchronous speed.

FIG. 4 illustrates one embodiment of the sensor signals. Graph 60 depicts a representation of motor rotation as power is applied in an oscillatory manner in alternating clockwise (cw) and counter-clockwise (ccw) rotational directions. In an embodiment, the motor may rotate for a one second period in each direction. In another embodiment, the period may be determined as 60 cycles of the AC supply. While graph 60 depicts instantaneous change in the cw to ccw to cw rotation, it is understood that there may be a delay between rotational direction changes. In other embodiments, the rotation may include periods of constant speed (including zero speed) or differences in rotational duration from period to period. Furthermore, the application of power to the motor may be shaped to other profiles such as a sine wave.

Referring to FIG. 4, graph 61 depicts a representation of the motor current as the direction changes from having no external load applied to the motor, allowing rotation of the sheaves and assist rope. The motor current changes direction at each period and may exhibit transient increases such those shown by 64 resulting from the inertial effects of the reversal of direction. Provided that the rotation is unimpeded, the average currents in either period may be nominally equivalent.

Graph 62 depicts a representation of the motor current as the direction changes from having a load applied to the assist rope in a selected direction. For purposes of illustration, when the motor rotates in the cw direction the assist rope provides support for a climber moving in the upward direction, and when the motor rotates in the ccw direction the assist rope provides support for a climber moving in the downward direction.

When the motor rotates in the cw direction and a load is applied to the assist rope in an upward direction, the power may decrease as the motor rotation is aided by the load, thereby reducing current 67. When the motor rotates in the ccw direction and a load is applied to the assist rope in an upward direction, power may increase as the motor rotation is resisted by the load, thereby increasing current 68. Current levels depicted by 69 and 70 illustrate the application of a load in the downward direction for the up and down directions, respectively.

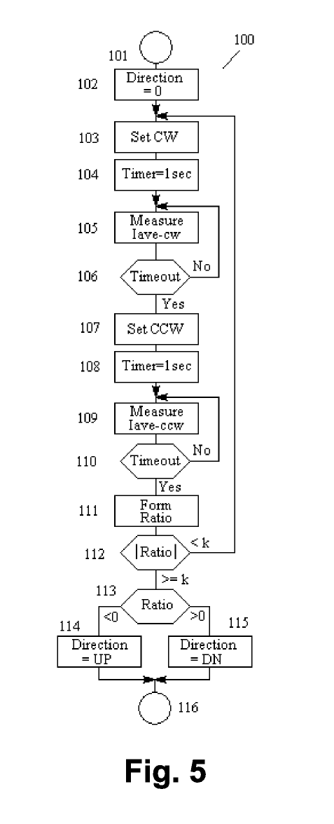

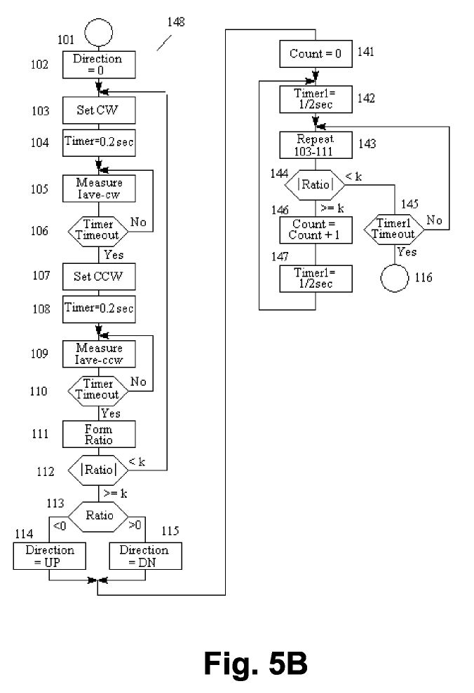

When a climber desires to provide a signal to the control system to initiate a climb in a selected direction and correspondingly initiate motor rotation to provide support in the selected direction, the algorithm in the controller may be arranged in accordance with the flowchart of FIG. 5.

Of course the motor could be driven slowly in one direction until a climber's intent was signaled and identified for further control of the climb. In a similar manner the change in measured current from the value measured when the belt was not loaded by a climber signaling intent.

Considering I₀ to be the current when the belt was running slowly in the up direction relative to the climber, then if the belt is tugged up, then from previous reasoning the motor current Iᵤₚ would be less than I₀, ie Iᵤₚ<I₀. If the belt was tugged in the down direction, then it would be expected that the motor current I_{down} would be greater than I₀, ie I_{down}>I₀. And similarly for the belt running in the down direction where the relationships are reversed as Iᵤₚ>I₀ and I_{down}<I₀.

Consequently, it is readily seen that running the motor to drive the belt in either an oscillatory or unidirectional manner may be used to provide a signaling capability to determine climber intent, with specific advantage to a motor with a worm type reduction gearbox.

One disadvantage of the unidirectional method is that the belt moves continuously which may be perceived as undesirable by the users, so the oscillatory method is regarded as preferable. Henceforth only the oscillatory method will be considered, although this does not preclude the unidirectional method.

Flowchart 100 of FIG. 5 illustrates a preferred embodiment of a climber support initiation algorithm. To sense the presence of an indication to initiate motion of the assist rope and hence support of a climber, the motor current may be sensed and an indication of a command to start or terminate support in the selected climb direction may be determined. The assist rope may be set to execute an oscillatory motion as depicted by graph 60. The oscillatory motion is primarily that of the motor, and the displacement of the assist rope is proportionately less according to the reduction ratio of the gearbox. The extent of the motion of the assist rope may be as small as needed to break the stiction of the gearbox where a worm type reduction is applied.

To reduce generation of noise from the gearbox caused by, for example, backlash in the gearing, the oscillatory motion may be shaped with an appropriate profile to limit gear shock as re-engagement of the gearing occurs at the direction reversal.

Referring to FIG. 5, during the period in which the system is waiting during the oscillatory state to determine a climber's next action, the portion of the algorithm from 103 through 112 may be continuously executed until the next action is determined. At block 102, the direction may be cleared to prevent other parts of the overall control algorithm from taking action.

At blocks 103 to 106, the motor may be set to rotating in a clockwise direction and the motor average current I_{ave-cw} may be determined over a selected period (e.g., 1 second). Upon the termination of the selected period, at blocks 107 to 110 the motor may be set rotating in a counterclockwise direction and the motor average current, I_{ave-ccw} may be determined over a selected period.

At block 111, the ratio may be computed from the determined average current as:

Ratio=(I_{ave-cw}+I_{ave-ccw})/(I_{ave-cw}−I_{ave-ccw}).

At block 112, if the absolute value of the ratio equals or exceeds a specified value, for example 0.3, then at block 113 it may be determined that an intentional change in load has occurred and the direction of the load as indicative of the climber's intent to initiate a climb may be determined. If the ratio is less than the specified value, then it may be determined that there has been no action to initiate a climb. Consequently, blocks 103 to 112 may continue to be performed.

At block 113, if the ratio is positive, then in block 115 the selected climb direction may be set to the downward direction, and otherwise the direction may be set to the upward direction in block 114.

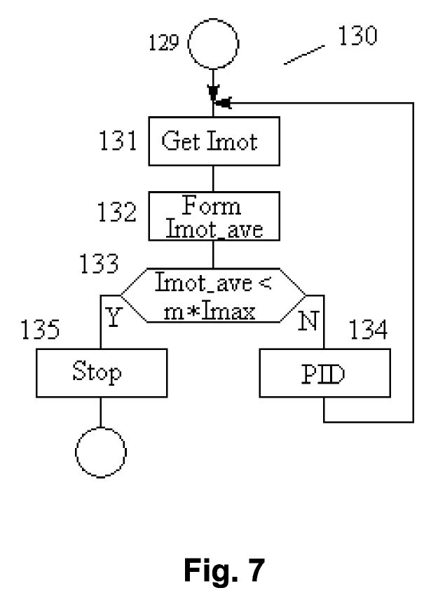

At block 116, the motor may be powered and controlled to provide a selected level of support to the climber and the controller may continue with algorithm 130 as shown in FIG. 7 and as further described below.

It will be recognized to those skilled in the art that the algorithms described herein have been simplified for the purpose of illustration and that additional capabilities may be added. For example, motor drive durations of voltage, profiles to shape the rotational rate of the sheave, and processes related to current measurement may optionally be added. Additionally and optionally, delays may be introduced to prevent unintended operation such as a start when a brief load is placed on the assist rope. In one embodiment, the climb assist system may be configured to wait for the climber to apply a sustained load in the intended direction of climb for two seconds in the upward direction and three seconds in the downward direction to initiate operation. Other wait times may be specified as needed.

FIG. 5B provides a further enhancement of the system as an algorithm such as could by implemented to add a signaling capability to said control system to change the specified level of support provided by said motor. For example if the climber tugs said belt more than once within a specified time then said algorithm may be arranged to interpret such additional signaling to set said support at specified levels. For example the first tug will determine the direction desired for climbing, and subsequent tugs, for example 2^{nd}, 3^{rd} and 4^{th} tugs within for example ½ second intervals could be recognized as being required to set 50, 80, and 110 lbs of support respectively.

Of course, other levels of support, intervals in support level, number of tugs and associated levels of support, and time interval may be defined to have alternative values.

With reference to FIG. 5B of the flowchart 148, elements 101 through 115 are identical to those of flowchart 100 (FIG. 5) and serve the same purpose which is to determine the direction in which the climber wishes to climb.

After the climb direction decision has been determined, at 141a counter Count 141 is cleared and at 142 a timer Timer 1 is initiated at ½ second. At 143, the functions 103 through 111 (of FIG. 5) are instantiated as previously described.

At 144 the ratio is computed as previously described from the determined average current as:

Ratio=(I_{ave-cw}+I_{ave-ccw})/(I_{ave-cw}−I_{ave-ccw}).

is evaluated relative to a threshold value k, for example but not necessarily 0.3, and if less than k then at 145 progress of Timer 1 is checked. If Timer 1 has timer out then the algorithm completes at 116, further control then takes place as the controller continues with the algorithm 130 (FIG. 7) as previously disclosed and said motor is powered and controlled to provide a specified level of support to the climber.

At 144 if said ratio is greater than or equal to said threshold value then counter Count is incremented, said Timer 1 is restarted, and the algorithm resumes at 142.

By the means as described, the value Count accumulates the successive number of tugs which may be used to set the desired level of support provided by said motor.

While the algorithms 100 and specifically 148 may be improved, for example by limiting the extent of counter Count, the concept of how a climber may use the belt 4 to signal climb direction and level of climber support is disclosed. Of course alternative algorithms may be proposed by those skilled in algorithm and control system methods, and where parameter values such as timer initial values and comparison values such as k are specified, alternative algorithms may specify other parameters and values to achieve similar signaling.

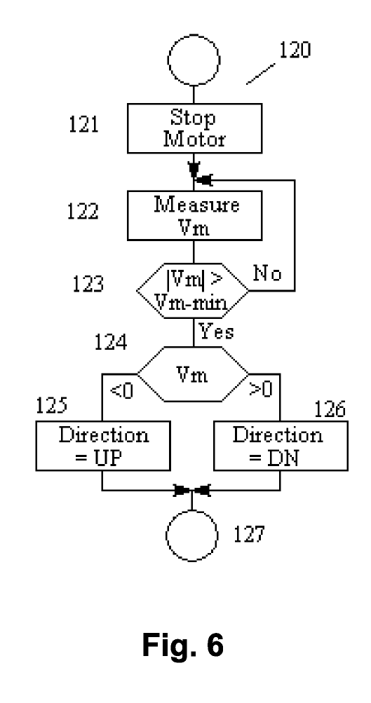

Flowchart 120 of FIG. 6 illustrates an alternative embodiment of an initiation algorithm which may be implemented wherein a motor capable of being back-driven is used. In this case, a forward-drive reduction gearbox between the sheave and motor may increase the force required to back-drive the motor.

If an unpowered PMDC motor is back-driven, the motor current may be assumed to be zero and the terminal voltage Vₘ may be determined according to the equation (1) as:

Vₘ=KₘNₘφ.

The polarity of Vₘ thus is a function of direction and the magnitude of Vₘ is a function of the speed of motor back-drive.

At block 121 the motor may be stopped. In the loop comprising blocks 122 and 123, it may be sensed whether the motor is rotating and generating voltage above a specified threshold Vₘ₋ₘᵢₙ. If so, the polarity or direction of rotation may be determined at block 124 and set at blocks 125 and 126.

For the purpose of illustration, the described algorithms have been simplified, but it should be recognized to those skilled in the art that that additional capabilities may be added. For example, motor drive durations for voltage, profiles to shape the rotational rate of the sheave, and processes related to current measurement may optionally be added. Additionally and optionally, delays may be introduced to prevent unintended operation such as a start when a brief load is placed on the assist rope. In one embodiment, the climb assist system may be configured to wait for the climber to apply a sustained load in the intended direction of climb for two seconds in the upward direction and three seconds in the downward direction to initiate operation. Other wait times may be specified as needed.

In one embodiment, the applied voltage may be tracked once a climb is initiated to prevent a sudden jerk when the changeover from sensing mode (FIG. 6) to controlling mode (FIG. 7) takes place.

Consequently, if the climber intends to start the motor and receive support, an alternative algorithm may sense that Vₘ has exceeded a threshold value for a specified time and use the polarity of Vₘ to determine the motor direction prior to initiating a further control algorithm as shown in FIG. 7.

At block 127, the motor may be powered and controlled to provide a selected level of support to the climber and the controller may continue with algorithm 130 as shown in FIG. 7 and further described below.

FIG. 7 illustrates a flowchart describing an embodiment of a control algorithm during an active climbing phase. In this embodiment control of the motor and hence the support during a climb may be provided. Referring to FIG. 7, control algorithm 130 may be entered at block 129. Once a climb has been initiated as in the flow chart of FIG. 5, FIG. 5b, or FIG. 6a, the motor current may be measured at block 131 and the average motor current updated at block 132. In an embodiment, the average motor current may be determined using an exponential averaging method using sampling relationship

Iₘₒₜ₋ₐᵥₑ₍ₜ₎=Iₘₒₜ₋ₐᵥₑ₍ₜ₋₁₎+α(Iₘₒₜ₍ₜ₎−Iₘₒₜ₋ₐᵥₑ₍ₜ₋₁₎)

where α with value ≦1 sets a rate for averaging, and subscripts t and t−1 refer to the current and previous epoch for the motor current samples, respectively. This relationship provides a computationally efficient means to determine average motor current.

In a preferred embodiment, the averaged motor current may be used for control to prevent transient currents from causing undesired torque changes. Other methods using the rate of change of current or other filtering methods may also be used.

At block 133, the average motor current may be compared with a threshold value m*Iₘₐₓ, where m may be set to 1.1 or 10% above the maximum set value. The value of m may be set to any useful value to detect a current that exceeds the expected operating value. Exceeding the expected operating value may signify that the climber has stopped climbing, thereby causing the motor to effectively stall and draw higher current than when the motor is running. The value Iₘₐₓ may be set to a value representative of the desired operating current to avoid unintentional stopping. In block 130, implicit time delays may be used to prevent a transient high current condition from causing an unintentional stop condition.

During the stopping phase, additional functionality may be added, such as requiring that the threshold be exceeded for a predetermined time. In one embodiment the predetermined time may be five seconds. If any selected criteria operative during the stopping phase is not met, then the algorithm may continue at 134 to cause a controller output to set a supply voltage for the motor, and otherwise the motor may be stopped to terminate support.

If a worm drive type reduction gearbox is employed, then when the motor is stopped, the reverse drive friction of the worm may be generally adequate to prevent further motion without requiring application of a friction brake. If the gearbox is a spur gear type or includes a direct drive motor where back drive may be readily achieved from the climber leaning back against the climb assist rope, a friction brake may be required to prevent unintended descent of the climber.

If the average motor current does not exceed the threshold value, then the algorithm may continue at block 134 and an algorithm such as a PID controller algorithm may provide a control signal to a motor drive to set the motor supply voltage 42. The motor supply voltage 42 may be set to maintain the motor average current at a specified target value corresponding to a specified level of support as input to the controller.

The selected level of support to a climber may be determined by the climber or operator according to climber weight. For example, a climber weighing 140 lbs may choose a support level of 75 lbs, whereas a climber weighing 220 lbs may choose a support level of 125 lbs. Other levels of support may be provided, and the selected level of support may be input to the controller using, for example, potentiometer 45. Alternatively, the level of support may be entered digitally from an associated switch or keyboard, or via a message from an external device or as previously disclosed by tugging on the rope.

The described algorithm has been simplified for illustrative purposes, and does not depict functions such as sampling, scaling of signals, timers, interrupts, and the like. Furthermore, alternative algorithm implementations for sensing motor current to manage activity in the system may be used.

In an embodiment, the control signals to the motor drive may be shaped to change the profile of the motor rotation and thereby reduce jerking in the climb assist rope. The profile may also be changed to reduce the reaction against backlash in the transmission of torque from the motor to the climb assist rope and reduce the resulting sound levels (particularly during direction changes), and reduce higher than desired current levels. Additionally, the algorithm may be further modified to provide acceleration and deceleration control as a function of the drive.

In another embodiment, the motor may be cycled continuously or semi-continuously in the cw and ccw directions until the motor is needed to provide climber support. In order to automatically turn the system off when no further use is desired, a light sensor may be used to detect that the local lights have been turned off, as may be used in a wind turbine tower or other indoor space. Alternatively, the system may be timed to turn off after a predetermined period, for example after three hours without activation of a climb.

In an embodiment, speed feedback may be provided and incorporated to further manage the climber support profile to reduce jerks and sudden changes of support and to increase climber comfort.

In another embodiment, power may be used to control support. By using a power control approach, the vector scalar product Vₘ·Iₘ (equation (7)) may be kept constant. From equation (10) it can be seen that as the support load on the belt changes, the torque inversely changes.

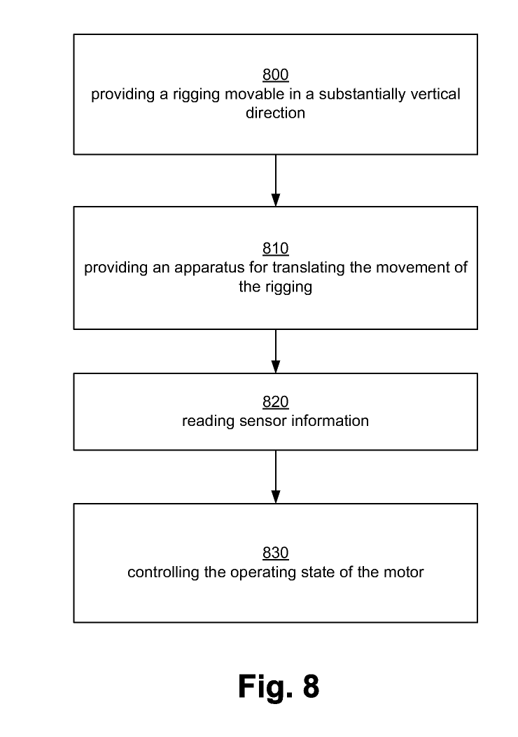

Referring now to FIG. 8, illustrated is an exemplary process for assisting a substantially vertical ascent or descent of a person including operations 800, 810, 820, and 830. The illustrated operations are exemplary and do not imply a particular order. Process 800 illustrates providing a rigging movable in a substantially vertical direction. Process 810 illustrates providing an apparatus for translating the movement of the rigging into ascent or descent assistance of the person. Process 820 illustrates reading sensor information indicative of a change in an operating state of a motor coupled to said rigging. For example, process 820 determines that a climber has tugged on an assist rope to request assistance in an up direction. Process 830 illustrates controlling the operating state of the motor based on the sensor information.

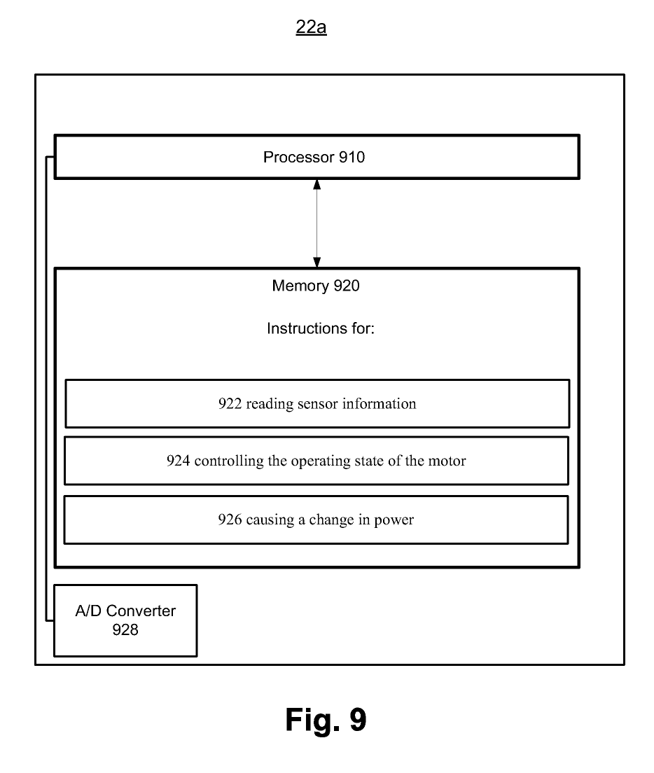

FIG. 9 depicts further details of controller 22a for assisting a substantially vertical ascent or descent of a person. Referring to FIG. 9, system 22a comprises a process 910 and memory 920. Memory 920 further comprises computer instructions for assisting a substantially vertical ascent or descent of a person. Block 922 illustrates computer instruction for receiving sensor information indicative of a change in an operating state of a motor coupled to a rigging for providing climber support. Block 924 illustrates computer instructions for controlling the operating state of the motor based on the sensor information. Block 926 illustrates computer instructions for causing a change in power as a function of the change in the operating state. A/D converter 928 reads various sensor information as depicted for example in FIG. 3. That information is then used by the various computer instructions in controlling the assist rope 4.

FIG. 9 illustrates an example of control of the state of the motor 20 wherein processor 910 as instructed with instructions 922 reads sensor information, for example, as measured by HED 41 proximate to a conductor 42 carrying current to said motor, said measure being digitized by A/D converter 928 and input to said processor, thereby providing control preferably of voltage to said motor and thereby control of the operating state of said motor 924 and consequently causing a change in motor power 926. It is noted that this computing structure is well known to those knowledgeable in the field of control systems.

As further definition of the state of the motor expressed as power, the equation (7 shows that motor state may be defined by the terms for scalar product of motor current and applied motor voltage which is proportional to motor rotational speed multiplied by torque at the motor drive shaft. Noting that torque is a function of the load applied by the belt 4 at the radius of the sheave 12, it may be seen that said load further expressed as the support experienced by the climber may be effectively controlled by controlling said voltage. Further from equation (2, it is seen that for a specified field flux, then said torque may be measured by a measure of motor current. It is obvious from FIG. 1 that said load is directly applied by the climber putting weight on belt 7 as described above and consequently the amount of support provided to the climber may be controlled.

Obviously said algorithm has been simplified for convenience of explanation, and does not depict functions such as sampling, scaling of signals, timers or interrupts, which are considered well known to those skilled in control systems design and implementation. Also, alternative expressions of an algorithm to sense motor current to manage activity in the system could be defined by those skilled in the art of algorithm design.

For example in another embodiment of an algorithm, shaping of said control signal to said motor drive may be used to change the profile of motor rotation and thereby reduce jerks in said belt, reduce reaction against backlash in the transmission of torque from said motor to said belt and resulting sound levels, particularly during direction changes, and also reduce higher than desired current levels. Additionally, other facilities may be included in said algorithm to provide acceleration and deceleration control as are well known and are often provided as a function of said drive.

As a further aspect of the system, it is noted that in one method of determining the intention to start said motor, the motor may be cycled continuously, or semi-continuously in the cw and ccw directions until required to provide support. Then to automatically turn the system off if no further use is required, a light sensor could be used to detect that the local lights have been turned off, for example in a wind turbine tower or other indoor space. Or alternatively, the system may be timed to turn off after a specified period, for example after 3 hours without activation of a climb.

Yet further aspect of the control system disclosed in this invention is to include speed feedback to further manage the profile of application of support to the climber to ensure that jerks and sudden changes of support are eliminated and to ensure climber comfort.

Another alternative for control which may be readily implemented is to use power to control support. By using the power control approach, the vector scalar product Vₘ·Iₘ (equation (7) could be kept constant. However from equation (10 it is seen that as support load on said belt changes, then torque would change inversely. This may be considered undesirable in some situation, but does provide another control alternative.

As a further alternative for control of the state of motor 20 in delivering a specified support to the climber, torque sensor 51 connected between the motor 20 and sheave 12 is such that the torque and therefore the load reflected by the climber may be directly sensed and input to A/D converter 928 to effect control of motor state according to equation (7 as previously described. Measurement of torque is well known to those skilled in control systems design and implementation.

Any of the above mentioned aspects can be implemented in methods, systems, computer readable media, or any type of manufacture. For example, a computer readable medium can store thereon computer executable instructions that when executed by a computing device can be used to detect a change in an operating state of a motor; read sensor information indicative of a change in an operating state of the motor; and control the operating state of the motor based on the sensor information. It will be appreciated by those skilled in the art that additional sets of instructions can be used to capture the various other aspects disclosed herein, and that the presently disclosed subsets of instructions can vary in detail per the present disclosure.

It is understood that the term circuitry used through the disclosure can include specialized hardware components. In the same or other embodiments circuitry can include microprocessors configured to perform function(s) by firmware or switches. In the same or other example embodiments circuitry can include one or more general purpose processing units and/or multi-core processing units, etc., that can be configured when software instructions that embody logic operable to perform function(s) are loaded into memory, e.g., RAM and/or virtual memory. In example embodiments where circuitry includes a combination of hardware and software, an implementer may write source code embodying logic and the source code can be compiled into machine readable code that can be processed by the general purpose processing unit(s). Additionally, computer executable instructions embodying aspects of the invention may be stored in ROM EEPROM, hard disk (not shown), RAM, removable magnetic disk, optical disk, and/or a cache of processing unit. A number of program modules may be stored on the hard disk, magnetic disk, optical disk, ROM, EEPROM or RAM, including an operating system, one or more application programs, other program modules and program data.

The foregoing description has set forth various embodiments of the apparatus and methods via the use of diagrams and examples. While the present disclosure has been described in connection with the preferred embodiments of the various figures, it is to be understood that other similar embodiments may be used or modifications and additions may be made to the described embodiment for performing the same function of the present disclosure without deviating there from. Furthermore, it should be emphasized that a variety of applications, including rock climbing, building escape or rescue methods, or any other application requiring vertical or near vertical transport of a person are herein contemplated. Therefore, the present disclosure should not be limited to any single embodiment, but rather construed in breadth and scope in accordance with the appended claims. Additional features of this disclosure are set forth in the following claims.

What is claimed:

1. A system for assisting a substantially vertical ascent or descent of a person, comprising:
a rigging movable in a vertical direction;
an apparatus coupled to said rigging, said apparatus adapted to couple a person to said rigging;
a motor coupled to said rigging;
a power source coupled to said oscillating motor;
a control mechanism operable to control the amount of power delivered to said motor;
a sensor configured to detect a change in an operating state of said motor; and
circuitry communicatively coupled to said control mechanism and configured to control the operating state of said motor in response to the detected change.

2. The system of claim 1, wherein control of the operating state of said motor comprises one of the group consisting of: causing said motor to shift from an oscillating state to a unidirectional state, causing said motor to shift from an unpowered state to a unidirectional state, and terminating operation of said motor.

3. The system of claim 1, wherein said rigging comprises a climb assist loop operable to continuously rotate more than one half revolution.

4. The system of claim 1, wherein the system is configured to support a selectable amount of the person's weight.

5. The system of claim 1, wherein said sensor is configured to detect a speed of said motor.

6. The system of claim 1, wherein detecting the change in the operating state comprises measuring an electric current of said motor, and wherein said measuring the electric current comprises determining an average motor current using an exponential averaging method.

7. The system of claim 1, wherein said control mechanism is operable to control the amount of power delivered to said motor by controlling at least one of the group consisting of: a voltage provided to said motor, a current provided to said motor, and the power provided to said motor based on a climber support profile

8. The system of claim 1, wherein said circuitry is further configured to wait for a predetermined period after detecting the change in the operating state and prior to controlling the operating state of said motor.

9. The system of claim 1, further comprising a Hall Effect Device (HED) configured to generate an electric signal that is representative of the detected change.

10. The system of claim 1, further comprising:
a processor; and
computing memory communicatively coupled to the processor, the computing memory having stored therein computer executable instructions for controlling the operating state of said motor in response to the detected change.

11. The system of claim 1, wherein the circuitry and the control mechanism are contained in a portable control box.

12. A device for controlling the substantially vertical ascent or descent of a person, comprising:
a sensor coupled to a control mechanism and operable to detect a change in an operating state of a motor adapted to provide motive support to a rigging for said vertical ascent or descent of a person; and
circuitry communicatively coupled to said control mechanism and configured to transmit control information for causing said control mechanism to control the operating state of said motor as a function of the detected change.

13. The device of claim 12, wherein the circuitry is contained in a portable control box.

14. A method for assisting the substantially vertical ascent or descent of a person, comprising:
providing a rigging movable in a substantially vertical direction;
providing an apparatus for translating the movement of the rigging into ascent or descent assistance of the person;
reading sensor information indicative of a change in an operating state of a motor coupled to said rigging; and
controlling the operating state of the motor based on the sensor information.

15. The method of claim 14, wherein said motor is an oscillating motor and said controlling the operating state comprises changing the operating state from an oscillating state to a unidirectional state.

16. The method of claim 15, wherein said controlling the operating state comprises changing the operating state from an unpowered state to a unidirectional powered state.
